(19) United States
(12) Patent Application Publication
(10) Pub. No.: US 2026/0214703 A1
(43) Pub. Date: Jul. 23, 2026

(54) SIDELINK RADIO LINK FAILURE ASSOCIATED WITH SIDELINK PERSISTENT LISTEN-BEFORE-TALK FAILURE

(71) Applicant: QUALCOMM Incorporated, San Diego, CA (US)

(72) Inventors: Qing LI, Princeton Junction, NJ (US); Stelios STEFANATOS, San Diego, CA (US); Giovanni CHISCI, San Diego, CA (US); Chih-Hao LIU, San Diego, CA (US); Ozcan OZTURK, San Diego, CA (US)

(21) Appl. No.: 19/157,841

(22) PCT Filed: Mar. 4, 2024
(86) PCT No.: PCT/US2024/018365

§ 371 Date: Aug. 19, 2025

(30) Foreign Application Priority Data
Apr. 6, 2023 (GR) 20230100294

(51) Int. Cl. H04W 74/0808; H04W 92/18

(52) U.S. Cl. CPC H04W 74/0808; H04W 92/18

(57) ABSTRACT

Various aspects of the present disclosure generally relate to wireless communication. In some aspects, a user equipment (UE) may detect that each resource block (RB) set of a group of RB sets is in sidelink persistent listen-before-talk (LBT) failure. The UE may attempt to recover one or more RB sets of the group of RB sets. The UE may selectively identify sidelink radio link failure (RLF) based at least in part on whether the one or more RB sets are recovered. Numerous other aspects are described.

### CROSS-REFERENCE TO RELATED APPLICATION

This Patent Application claims priority to Greek Patent Application No. 20230100294, filed on Apr. 6, 2023, entitled “SIDELINK RADIO LINK FAILURE ASSOCIATED WITH SIDELINK PERSISTENT LISTEN-BEFORE-TALK FAILURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink radio link failure associated with persistent listen-before-talk failure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include detecting that each resource block (RB) set of a group of RB sets is in sidelink persistent listen-before-talk (LBT) failure. The method may include attempting to recover one or more RB sets of the group of RB sets. The method may include selectively identifying sidelink radio link failure (RLF) based at least in part on whether the one or more RB sets are recovered.

Some aspects described herein relate to a method of wireless communication performed by a UE. The method may include detecting sidelink persistent LBT failure of each RB set of a group of RB sets. The method may include identifying sidelink RLF based at least in part on detection of the sidelink persistent LBT failure of each RB set of the group of RB sets.

Some aspects described herein relate to a UE for wireless communication. The user equipment may include a memory and one or more processors coupled to the memory. The one or more processors may be configured to detect that each RB set of a group of RB sets is in sidelink persistent LBT failure. The one or more processors may be configured to attempt to recover one or more RB sets of the group of RB sets. The one or more processors may be configured to selectively identify sidelink RLF based at least in part on whether the one or more RB sets are recovered.

Some aspects described herein relate to a UE for wireless communication. The UE may include a memory and one or more processors coupled to the memory. The one or more processors may be configured to detect sidelink persistent LBT failure of each RB set of a group of RB sets. The one or more processors may be configured to identify sidelink RLF based at least in part on detection of the sidelink persistent LBT failure of each RB set of the group of RB sets.

Some aspects described herein relate to a non-transitory computer-readable medium that stores a set of instructions for wireless communication by a UE. The set of instructions, when executed by one or more processors of the UE, may cause the UE to detect that each RB set of a group of RB sets is in sidelink persistent LBT failure. The set of instructions, when executed by one or more processors of the UE, may cause the UE to attempt to recover one or more RB sets of the group of RB sets. The set of instructions, when executed by one or more processors of the UE, may cause the UE to selectively identify sidelink RLF based at least in part on whether the one or more RB sets are recovered.

Some aspects described herein relate to a non-transitory computer-readable medium that stores a set of instructions for wireless communication by UE. The set of instructions, when executed by one or more processors of the UE, may cause the UE to detect sidelink persistent LBT failure of each RB set of a group of RB sets. The set of instructions, when executed by one or more processors of the UE, may cause the UE to identify sidelink RLF based at least in part on detection of the sidelink persistent LBT failure of each RB set of the group of RB sets.

Some aspects described herein relate to an apparatus for wireless communication. The apparatus may include means for detecting that each RB set of a group of RB sets is in sidelink persistent LBT failure. The apparatus may include means for attempting to recover one or more RB sets of the group of RB sets. The apparatus may include means for selectively identifying sidelink RLF based at least in part on whether the one or more RB sets are recovered.

Some aspects described herein relate to an apparatus for wireless communication. The apparatus may include means for detecting sidelink persistent LBT failure of each RB set of a group of RB sets. The apparatus may include means for identifying sidelink RLF based at least in part on detection of the sidelink persistent LBT failure of each RB set of the group of RB sets.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of triggering radio link failure (RLF) based at least in part on detecting persistent listen-before-talk (LBT) failure on sidelink resource block (RB) sets that a UE attempts to use for transmission, in accordance with the present disclosure.

FIG. 7 is a diagram of an example associated with sidelink RLF associated with sidelink persistent LBT failure, in accordance with the present disclosure.

FIG. 8 is a diagram of an example associated with sidelink RLF associated with sidelink persistent LBT failure, in accordance with the present disclosure.

FIG. 9 is a diagram of an example associated with sidelink RLF associated with sidelink persistent LBT failure, in accordance with the present disclosure.

FIG. 10 is a diagram of an example associated with sidelink RLF associated with sidelink persistent LBT failure, in accordance with the present disclosure.

FIG. 11 is a diagram of an example associated with sidelink RLF associated with sidelink persistent LBT failure, in accordance with the present disclosure.

FIG. 12 is a diagram of an example associated with sidelink RLF associated with sidelink persistent LBT failure, in accordance with the present disclosure.

FIG. 13 is a diagram illustrating an example process performed, for example, by a UE, in accordance with the present disclosure.

FIG. 14 is a diagram illustrating an example process performed, for example, by a UE, in accordance with the present disclosure.

FIG. 15 is a diagram of an example apparatus for wireless communication, in accordance with the present disclosure.

### DETAILED DESCRIPTION

Various aspects relate generally to radio link failure (RLF) associated with sidelink persistent listen-before-talk (LBT) failures. Some aspects more specifically relate to when to trigger a sidelink RLF procedure after detecting that each resource block (RB) set of a group of RB sets is in sidelink persistent LBT failure. In some examples, the user equipment (UE) may identify sidelink RLF based at least in part on all RB sets of the group of RB sets failing an attempted recovery from sidelink persistent LBT failure. In some aspects, the UE may identify sidelink RLF based at least in part on detecting sidelink persistent LBT failure on each of the RB sets of the group of RB sets.

Particular aspects of the subject matter described in this disclosure can be implemented to realize one or more of the following potential advantages. In some examples, the described techniques can be used to conserve network resources (e.g., overhead) that may otherwise be used to tear down and reestablish all sidelink radio links in association with RLF. Additionally, or alternatively, the UE may improve latency of communications that may otherwise be delayed based at least in part on tearing down and reestablishing all sidelink radio links in associated with RLF. A UE may be more likely to recover a sidelink RB set than to improve signal strength in a Uu connection when detecting indications of potential RLF in the Uu connection based at least in part on sidelink persistent LBT failure being less-predictable than indicators of RLF in a Uu connection and/or causes of sidelink LBT failure being inconsistent.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

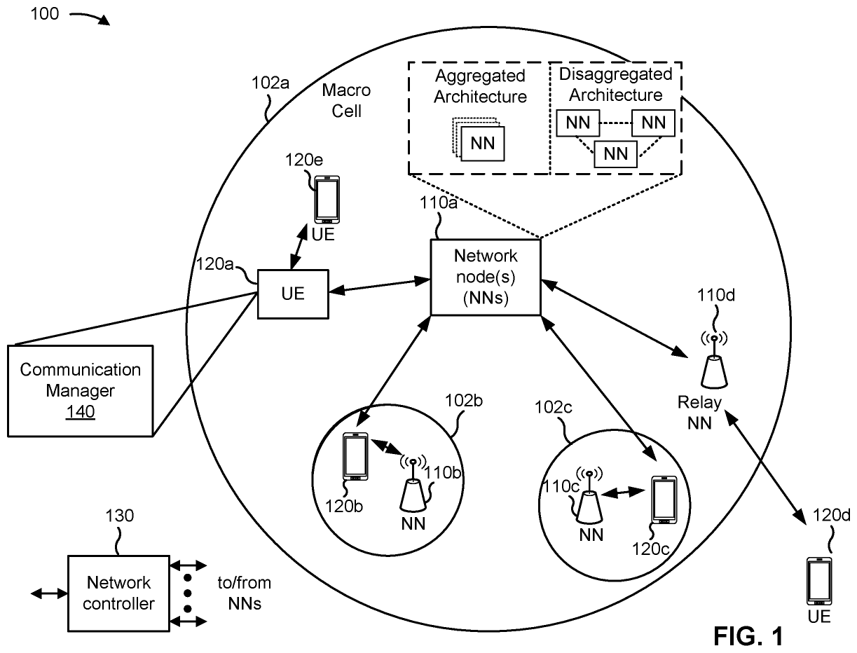

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may detect that each RB set of a group of RB sets is in sidelink persistent LBT failure; attempt to recover one or more RB sets of the group of RB sets; and selectively identify sidelink RLF based at least in part on whether the one or more RB sets are recovered. Additionally, or alternatively, the communication manager 140 may perform one or more other operations described herein.

In some aspects, the UE 120 may include a communication manager 140. As described in more detail elsewhere herein, the communication manager 140 may detect sidelink persistent LBT failure of each RB set of a group of RB sets; and identify sidelink RLF based at least in part on detection of the sidelink persistent LBT failure of each RB set of the group of RB sets. Additionally, or alternatively, the communication manager 140 may perform one or more other operations described herein.

As indicated above, FIG. 1 is provided as an example. Other examples may differ from what is described with regard to FIG. 1.

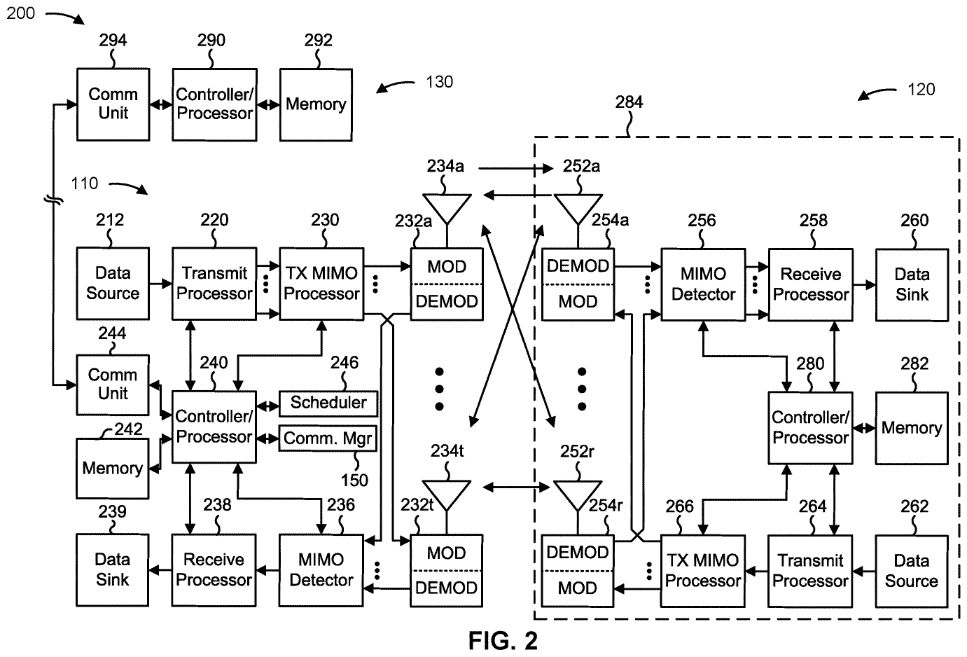

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

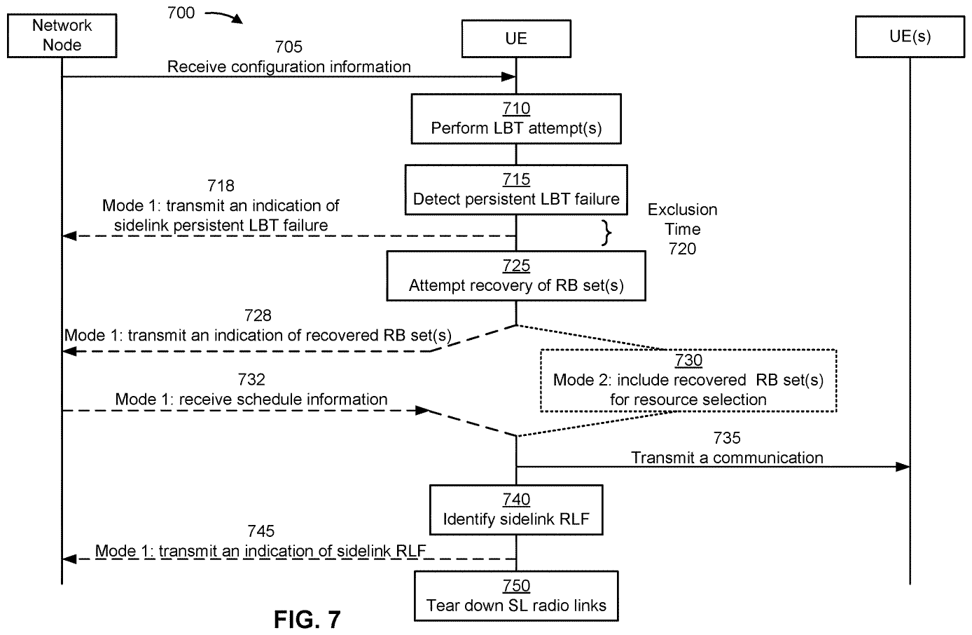

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-15).

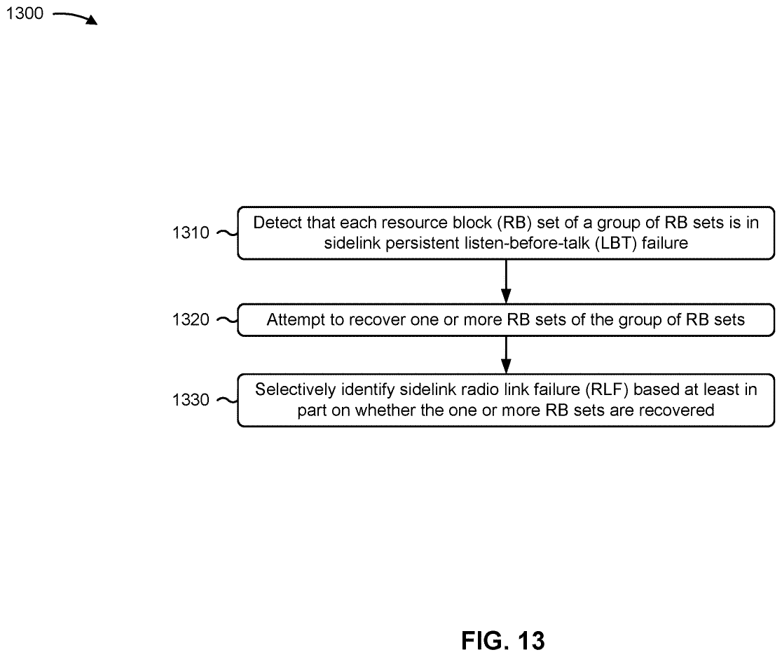

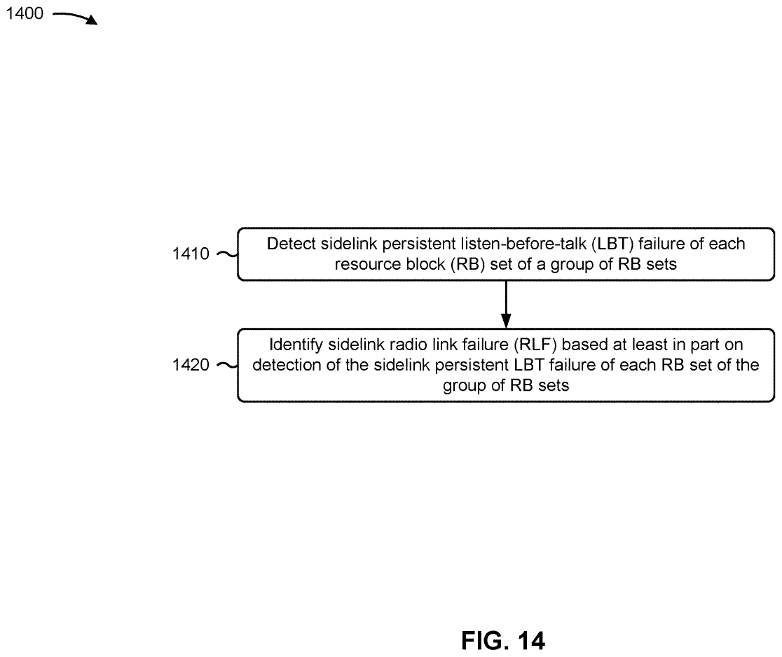

The controller/processor 240 of the network node 110, the controller/processor 280 of the UE 120, and/or any other component(s) of FIG. 2 may perform one or more techniques associated with sidelink RLF associated with sidelink persistent LBT failure, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE includes means for detecting that each RB set of a group of RB sets is in sidelink persistent LBT failure; means for attempting to recover one or more RB sets of the group of RB sets; and/or means for selectively identifying sidelink RLF based at least in part on whether the one or more RB sets are recovered. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for detecting sidelink persistent LBT failure of each RB set of a group of RB sets; and/or means for identifying sidelink RLF based at least in part on detection of the sidelink persistent LBT failure of each RB set of the group of RB sets. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

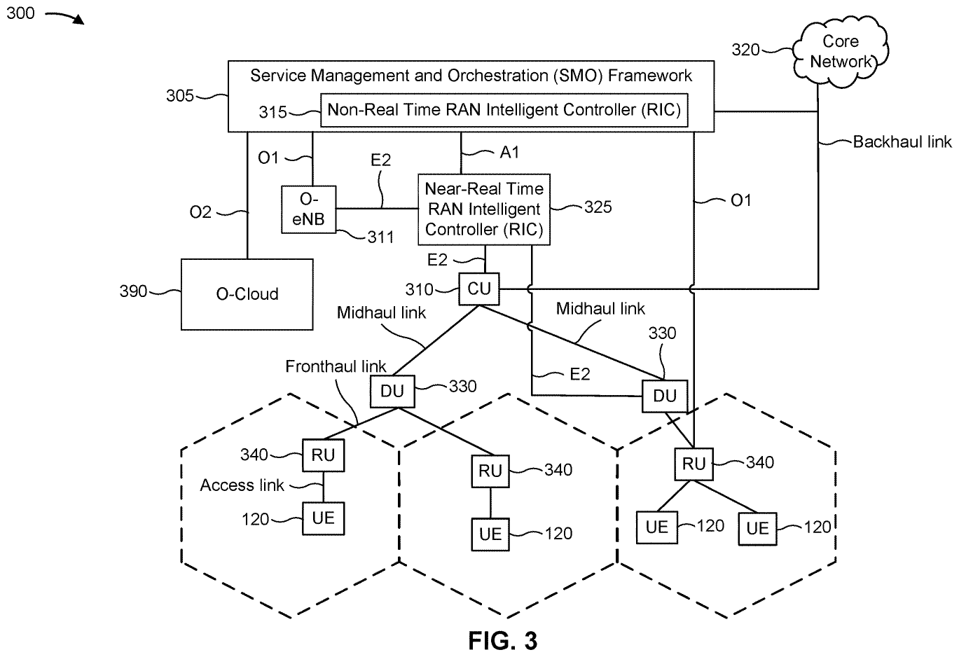

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325.

The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

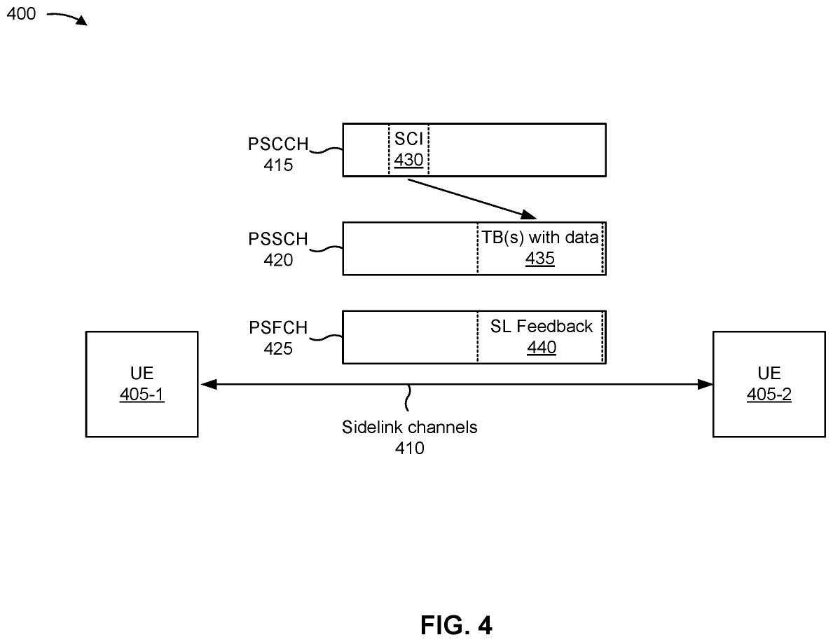

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) for transmitting the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink resource allocation mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a resource allocation mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSCCH-RSRP or PSSCH-RSRP parameter) associated with various sidelink channels, and/or may measure an RSRQ parameter (e.g., a PSCCH-RSRQ or PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the resource allocation mode where resource selection and/or scheduling is performed by a UE 405 (e.g., Mode 2), the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message (e.g., an aperiodic sidelink transmission).

As indicated above, FIG. 4 is provided as an example. Other examples may differ from what is described with respect to FIG. 4.

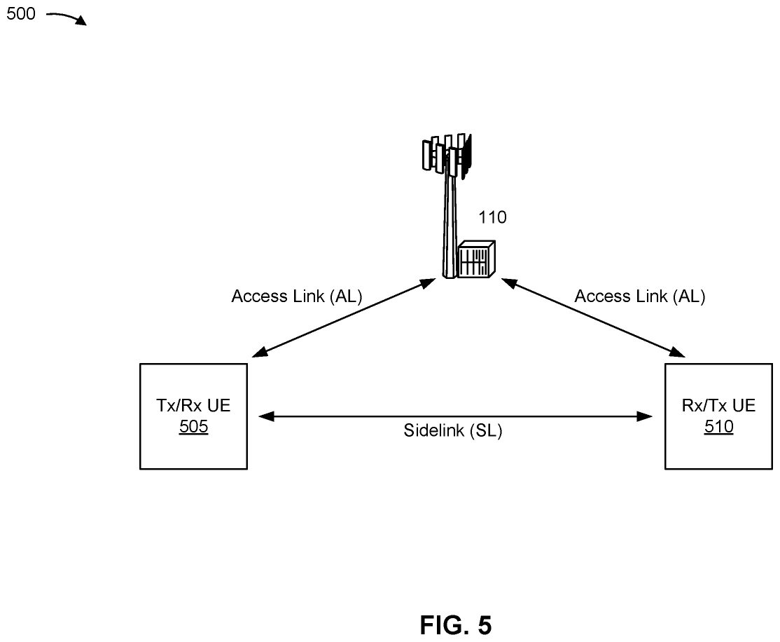

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

In some networks that support sidelink communication (e.g., on an unlicensed spectrum), a UE may perform an LBT procedure in which the UE monitors a group of RB sets (e.g., a group of LBT channels where an LBT procedure is conducted with each LBT channel) to detect whether one or more RB sets of the group of RB sets are available for communication or occupied by a transmission by another device. Based at least in part on detecting availability of the one or more RB sets of the group of RB sets for a period of time (e.g., a contention window for LBT procedure), the UE may transmit a communication using the one or more RB sets of the group of RB sets. Alternatively, the UE may use a different one or more RB sets of the group of RBs for transmission based at least in part on the channel being occupied.

A of RB set may be identified as having persistent LBT failure based at least in part on the RB set failing the LBT procedure (e.g., detected as being unavailable) for a number of consecutive attempts that satisfies a threshold, for a percentage of consecutive attempts that satisfies a threshold, and/or based at least in part on another metric associated with the RB set being unlikely to be available for transmission by the UE.

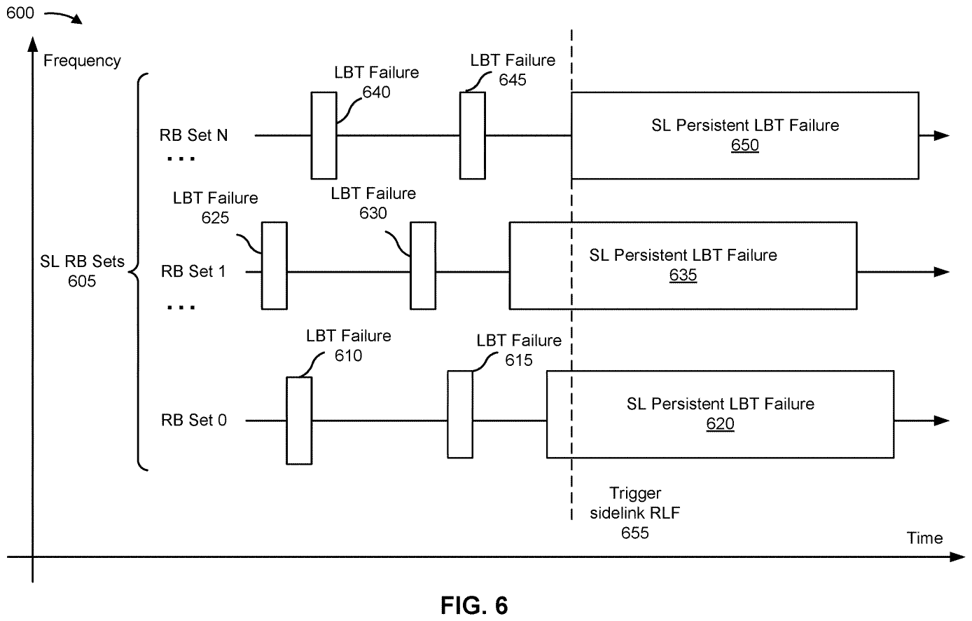

FIG. 6 is a diagram illustrating an example 600 of triggering RLF based at least in part on detecting sidelink persistent LBT failure on sidelink RB sets that a UE attempts to use for transmission, in accordance with the present disclosure. In the context of FIG. 6, a UE may attempt to use resources of a group of sidelink (SL) RB sets 605, which may be within one or multiple resource pools within a sidelink bandwidth part (SL BWP) to transmit communications to one or more UEs. An RB set may be referred to as an LBT channel. For example, the RB set may include a 20 MHz bandwidth for an LBT procedure. For a bandwidth larger than 20 MHz, the UE may use more than one RB sets for LBT procedures. For example, a 40 MHz bandwidth may have 2 RB sets which require an LBT procedure on each of the 2 RB sets (e.g., LBT on each 20 MHz).

The UE may attempt to use resources of any of RB sets 0 through RB set N. The UE may perform one or more LBT procedures on the sidelink RB sets 605 to obtain resources for transmitting the communications to the one or more UEs. As shown in FIG. 6, the UE may detect an LBT failure 610 and an LBT failure 615 on RB set 0. Based at least in part on detecting the LBT failures 610 and 615 on the RB set 0, the UE may detect that the RB set 0 is in sidelink persistent LBT failure 620. The UE may detect an LBT failure 625 and an LBT failure 630 on RB set 1. Based at least in part on detecting the LBT failures 625 and 630 on the RB set 1, the UE may detect that the RB set 1 is in sidelink persistent LBT failure 635. The UE may detect an LBT failure 640 and an LBT failure 645 on RB set N. Based at least in part on detecting the LBT failures 640 and 645 on the RB set N, the UE may detect that the RB set Nis in sidelink persistent LBT failure 650.

In some networks, the UE may trigger RLF 655 based at least in part on all of the sidelink RB sets 605 being in sidelink persistent LBT failure. For example, the UE may trigger RLF 655 based at least in part on detecting sidelink persistent LBT failure on a last remaining RB set.

In some examples, an RB set may remain in an sidelink persistent LBT failure until an RLF is triggered. In this way, the UE may have access to fewer and fewer candidate resources for transmission of a sidelink communication.

In some examples, based at least in part on triggering RLF 655, the UE may release data radio bearers (DRBs) of all sidelink radio links, release signaling radio bearers (SRBs) of all sidelink radio links, discard sidelink communication-related configuration for all sidelink radio links, reset sidelink-specific MACs of all sidelink radio links, consider a PC5-RRC connection as released for all sidelink radio links, and/or indicate a release of the PC5-RRC connection to upper layers (e.g., a service layer) for each of the sidelink radio links.

As indicated above, FIG. 6 is provided as an example. Other examples may differ from what is described with respect to FIG. 6.

Based at least in part on computing, power, network, and communication resources consumed based at least in part on triggering sidelink RLF, frequently claimed sidelink RLFs can be disruptive to sidelink communications and costly to recover (e.g., to re-establish PC5 RRC connections, reset up radio bearers, and/or reconfigure sidelink communications, among other examples). Claiming sidelink RLF immediately after a last remaining RB set is detected with sidelink persistent LBT failure may be premature and unnecessarily costly based at least in part on a likelihood that at least one RB set with sidelink persistent LBT failures may be recovered from persistent LBT failure.

Various aspects relate generally to sidelink RLF associated with sidelink persistent LBT failures. Some aspects more specifically relate to when to trigger a sidelink RLF procedure after detecting that each RB set of a group of RB sets is in sidelink persistent LBT failure. In some examples, the UE may identify sidelink RLF based at least in part on all RB sets of the group of RB sets failing an attempted recovery from sidelink persistent LBT failure. In some aspects, the UE may identify sidelink RLF based at least in part on detecting sidelink persistent LBT failure on each of the group of RB sets.

Particular aspects of the subject matter described in this disclosure can be implemented to realize one or more of the following potential advantages. In some examples, the described techniques can be used to conserve network resources (e.g., overhead) that may otherwise be used to tear down and reestablish all sidelink radio links in association with sidelink RLF. Additionally, or alternatively, the UE may improve latency of communications that may otherwise be delayed based at least in part on tearing down and reestablishing all sidelink radio links in associated with sidelink RLF. A UE may be more likely to recover a sidelink RB set than to improve signal strength in a Uu connection when detecting indications of potential RLF in the Uu connection based at least in part on sidelink persistent LBT failure being less-predictable than indicators of the RLF in a Uu connection and/or causes of sidelink LBT failure being inconsistent.

In some aspects, the UE may identify sidelink RLF (e.g., trigger sidelink RLF) based at least in part on failure of sidelink persistent LBT failure recovery on all RB sets in a group of RB sets that the UE attempts to use for transmission of a communication. In some aspects, the UE may identify sidelink RLF based at least in part on failure of sidelink persistent LBT failure recovery on all RB sets after a first sidelink persistent LBT timer expires while other sidelink persistent LBT timers are still running. In some aspects, the UE may identify sidelink RLF based at least in part on failure of sidelink persistent LBT failure recovery on all RB sets after a last sidelink persistent LBT timer expires while other sidelink persistent LBT timers are still running. In some aspects, the UE may identify sidelink RLF based at least in part on failure of sidelink persistent LBT failure recovery on all RB sets after a delay from failing the first sidelink persistent LBT failure recovery after the expiration of the sidelink persistent LBT timer.

In some aspects, sidelink RLF may be identified without requiring an attempt to recover the RB sets. For example, the UE may identify sidelink RLF based at least in part on the UE having no available (e.g., non-excluded) RB sets within a sensing window and/or the UE detecting sidelink persistent LBT failure for all RB sets within the sensing window.

FIG. 7 is a diagram of an example 700 associated with sidelink RLF associated with sidelink persistent LBT failure, in accordance with the present disclosure. As shown in FIG. 7, a UE (e.g., UE 120) may communicate with a network node (e.g., network node 110, a CU, a DU, and/or an RU) and one or more UEs (e.g., UE 120). In some aspects, the network node, the UE, and the one or more UEs may be part of a wireless network (e.g., wireless network 100). The UE and the network node may have established a wireless connection prior to operations shown in FIG. 7.

As shown by reference number 705, the network node may transmit, and the UE may receive, configuration information. In some aspects, the UE may receive the configuration information via one or more of RRC signaling (e.g., initial configuration or reconfiguration), one or more MAC control elements (MAC CEs) (e.g., activating or deactivating a configuration), and/or DCI (e.g., dynamically indicating a configuration), among other examples. In some aspects, the configuration information may include an indication of one or more configuration parameters (e.g., activating or indicating one of the configurations already known to the UE and/or previously indicated by the network node or other network device) for selection by the UE, and/or explicit configuration information for the UE to use, among other examples.

In some aspects, the configuration information may indicate one or more parameters for communicating with the one or more UEs via sidelink communications. In some aspects, the one or more parameters may indicate sidelink persistent LBT failure timer(s) (e.g., an exclusion time) and/or time period(s) for detecting sidelink persistent LBT failure for one or more RB sets and/or associated with one or more communication parameters (e.g., QoS requirements or QoS profiles for one or more sidelink communications using the one or more RB sets). In some aspects, the one or more parameters may indicate a duration of a recovery window, a trigger to initiate the recovery window, and/or a threshold of measurement(s) for detecting availability of an RB set within the recovery window. In some aspects, the one or more parameters may indicate a threshold number of RB sets for detecting availability of a number of RB sets within the recovery window. In some aspects, the configuration information may indicate a duration of a detection window used to identify sidelink RLF, as described in connection with reference number 740.

The UE may configure itself based at least in part on the configuration information. In some aspects, the UE may be configured to perform one or more operations described herein based at least in part on the configuration information, for example, communicating on sidelink with resource allocation mode 1 (Mode 1) or mode 2 (Mode 2). In some aspects with Mode 1, the UE may receive resources for transmissions on sidelink using one or more RB sets of a group of RB sets, for example, resources configured (e.g., RRC configuration) with configured grant type 1, resources activated (e.g., activation with MAC CE or DCI) with configured grand type 2. In some aspects with Mode 2, the UE may sense and select resources for transmissions on sidelink using one or more RB sets of a group of RB sets.

As shown by reference number 710, the UE may perform one or more LBT attempts. For example, the UE may monitor one or more RB sets (e.g., as configured, activated or indicated by the network node in Mode 1 or as selected by the UE in Mode 2) during an LBT contention window to identify occupancy or availability of each RB set of the one or more RB sets.

As shown by reference number 715, the UE may detect sidelink persistent LBT failure for the one or more RB sets. In some aspects with Mode 1, as shown by reference number 718, the UE may transmit an indication to the network node indicating sidelink persistent LBT failure associated to the one or more RB sets (e.g., including a sidelink persistent LBT failure flag (for example, with value “1”) and a list of one or more RB sets with sidelink persistent LBT failures). In some aspects with Mode 2, based at least in part on detecting sidelink persistent LBT failure, an associated RB set may be excluded from candidate resources selection or resource selection for Mode 2 for the UE to monitor for availability to transmit a sidelink communication.

As shown by reference number 720, the UE may apply an exclusion time (e.g., sidelink persistent LBT failure timer) to the one or more RB sets based at least in part on detecting the sidelink persistent LBT failure. In some aspects, the different RB sets may be associated with different exclusion times time (e.g., different sidelink persistent LBT failure timers). For example, exclusion times may be based at least in part on communication types and/or QoS requirements of communications for which LBT failed, among other examples.

Alternatively, each of the RB sets may have a same exclusion time.

As shown by reference number 725, the UE may attempt recovery of the one or more RB sets. In some aspects, the UE may attempt to recover the one or more RB sets (e.g., each RB set) (e.g., within a recovery window). The recovery window may begin at expiration of an exclusion time initiated at detection of a RB set with sidelink persistent LBT failure within the time period for sidelink persistent LBT failure detection.

In some aspects, the UE may attempt to recover the one or more RB sets after expiration of respective exclusion times 720. The UE may again attempt to recover the one or more RB sets (e.g., during the recovery window). In some aspects, attempting to recover the one or more RB sets may include attempting to recover the one or more RB sets based at least in part on performing successful LBT sensing within a respective RB set, receiving one or more signals or communications within the respective RB set, and/or measuring one or more channel busy ratio (CBR) and channel occupancy ratio (CR) or RSSI to satisfy a threshold, among other examples.

In some aspects with Mode 1, as shown by reference number 728, the UE may transmit an indication to the network node indicating sidelink persistent LBT failure recovery associated to the one or more RB sets (e.g., including a sidelink persistent LBT failure recovery flag (for example, with value “1”) or the sidelink persistent LBT failure flag (for example, with value “0”) and a list of one or more RB sets recovered from the sidelink persistent LBT failures). In some aspects with Mode 1, as shown by reference number 732, the UE may receive a schedule from the network node indicating a sidelink grant using the one or more RB sets recovered from sidelink persistent LBT failures.

In some aspects with Mode 2, as shown by reference number 730, the UE may include one or more recovered RB sets for resource candidate selection or resource selection.

For example, the one or more recovered RB sets may no longer be excluded from a pool of candidate resources or resource selection window that the UE may attempt to use (e.g., via an LBT procedure) to transmit a communication.

As shown by reference number 735, the UE may transmit a communication to the one or more UEs. In some aspects, the UE may use a recovered RB set to transmit the communication.

As shown by reference number 740, the UE may identify sidelink RLF. For example, if the attempt of recovery for each RB set of the one or more RB sets described in connection with reference number 725 fails, the UE may have no candidate RB sets to use to attempt to transmit a communication. In this case, the UE is unable to communicate and may identify sidelink RLF.

In some aspects, the UE may identify sidelink RLF based at least in part on detecting that each RB set of the group of RB sets is in sidelink persistent LBT failure (e.g., during a time period). In some aspects, the UE may attempt to recover each RB set of the one or more RB sets (e.g., within a recovery window). The recovery window may being at expiration of an exclusion time initiated at detection of a first RB set with sidelink persistent LBT failure (e.g., within the time period for sidelink persistent LBT failure detection), a time that is offset from the first recovery failure after the expiration of an exclusion time initiated at detection of the first RB set with sidelink persistent LBT failure (e.g., within the time period), or expiration of an exclusion time initiated at detection of a last RB set with sidelink persistent LBT failure (e.g., within the time period), among other examples. The UE may have failed in attempts to recover each RB set of the group of RB sets, which provided no available candidate resources for the UE to use to attempt to transmit a communication. In some aspects, the UE may identify sidelink RLF based at least in part on failing to recover a threshold number (e.g., 1, 2, or a percentage of the RB groups) of the one or more RB sets. Alternatively, the UE may refrain from identifying RLF based at least in part on recovery of the threshold number of the one or more RB sets.

In some aspects, the UE may identify sidelink RLF based at least in part on detecting sidelink persistent LBT failure of each RB set of the group of RB sets (e.g., within a detection window, such as a sensing window or resource selection window). For example, the UE may identify sidelink RLF independently from (e.g., without requiring) the attempt of recovery of the one or more RB sets, as described in connection with reference number 725. In some aspects, the UE may identify sidelink RLF based at least in part on detections of the sidelink persistent LBT failures occurring within the detection window and/or based at least in part on each of the RB groups being in sidelink persistent LBT failure for the entire detection window (e.g., such that no RB sets have candidate resources for a transmission within a sensing window or resource selection window).

In some aspects, the UE may provide an indication of the sidelink RLF to a service layer or another high-layer entity of the UE.

In some aspects with Mode 1, as shown by reference number 745, the UE may transmit an indication of sidelink RLF to the network node. For example, the UE may indicate that the UE is to tear down sidelink radio links based at least in part on failing to have access to available resources.

As shown by reference number 750, the UE may tear down sidelink radio links with the one or more UEs.

The described techniques can be used to conserve network resources (e.g., overhead) that may otherwise be used to tear down and reestablish all sidelink radio links in association with an unnecessary sidelink RLF. Additionally, or alternatively, the UE may improve latency of communications that may otherwise be delayed based at least in part on tearing down and reestablishing all sidelink radio links in association with sidelink RLF.

As indicated above, FIG. 7 is provided as an example. Other examples may differ from what is described with respect to FIG. 7.

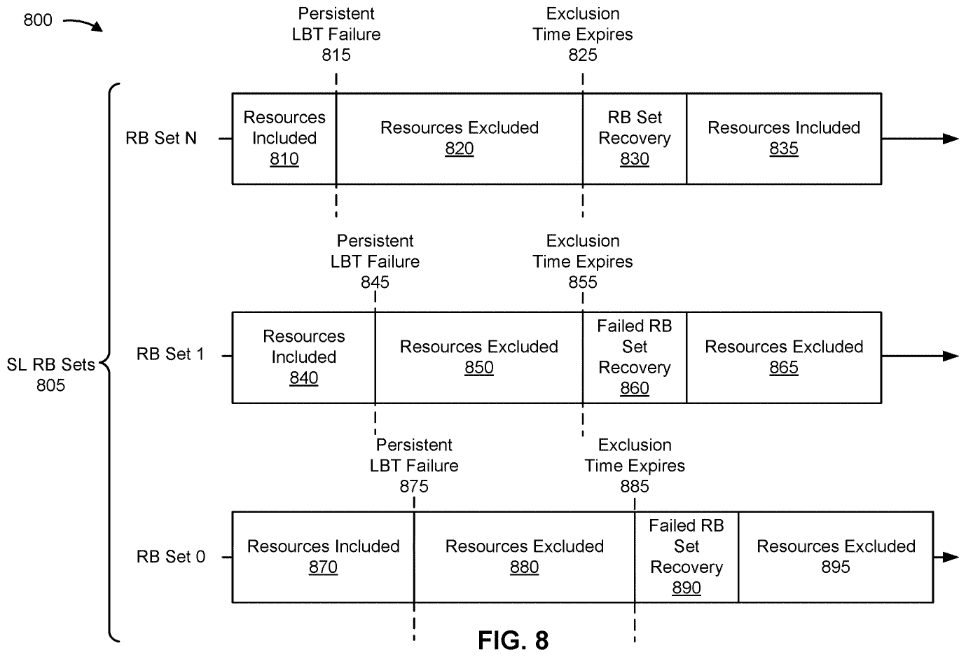

FIG. 8 is a diagram of an example 800 associated with sidelink persistent LBT failure and recovery, in accordance with the present disclosure. In the context of FIG. 8, a UE may attempt to use resources of a group of sidelink RB sets 805 which may be within one or multiple resource pools of a sidelink bandwidth part to transmit communications to one or more UEs.

The UE may attempt to use resources of any of RB sets 0 through RB set N to transmit a communication via a sidelink radio link. As shown in FIG. 8, the RB set N may have resources included 810 in a pool for candidate resource selection or resource selection as with RA mode 2 or as configured or activated or indicated by the network node with RA mode 1 for transmitting. The UE may perform an LBT procedure on the RB set N to determine whether resources of the RB set N are available for transmitting a communication while the resources of RB set N are included.

As shown in FIG. 8, the UE may detect sidelink persistent LBT failure 815 which may cause resources of the RB set N to be excluded as resources excluded 820. As shown by reference number 825, an exclusion time expires, which may cause the UE to initiate an RB set recovery 830 for the RB set N. Based at least in part on the recovery being successful (e.g., as described with details in FIG. 7), the resources of RB set N may be identified as resources included 835 within the pool of candidate resources for transmitting.

As shown in FIG. 8, the RB set 1 may have resources included 840 in the pool for candidate resource selection or resource selection as with RA mode 2 or as configured or activated or indicated by the network node with RA mode 1 for transmitting. The UE may perform an LBT procedure on the RB set 1 to determine whether resources of the RB set 1 are available for transmitting a communication while the resources of RB set 1 are included.

As shown in FIG. 8, the UE may detect sidelink persistent LBT failure 845 which may cause resources of the RB set 1 to be excluded as resources excluded 850. As shown by reference number 855, an exclusion time expires, which may cause the UE to initiate an RB set recovery (failed RB set recovery 860) for the RB set 1. Based at least in part on the recovery failing, the resources of RB set 1 may be identified as resources excluded 865 from the pool of candidate resources for transmitting.

As shown in FIG. 8, the RB set 0 may have resources included 870 in the pool for candidate resource selection or resource selection as with RA mode 2 or as configured or activated or indicated by the network node with RA mode 1 for transmitting. The UE may perform an LBT procedure on the RB set 0 to determine whether resources of the RB set 0 are available for transmitting a communication while the resources of RB set 0 are included.

As shown in FIG. 8, the UE may detect sidelink persistent LBT failure 875 which may cause resources of the RB set 0 to be excluded as resources excluded 880. As shown by reference number 885, an exclusion time expires, which may cause the UE to initiate an RB set recovery (failed RB set recovery 890) for the RB set 0. Based at least in part on the recovery failing, the resources of RB set 0 may be identified as resources excluded 895 from the pool of candidate resources for transmitting.

With one or more RB sets within a resource pool or sidelink BWP configured, pre-configured, or selected by the UE (e.g., RA mode 2) or by a network node (e.g., RA mode 1), the UE (e.g., a transmitting UE) may be configured or pre-configured with a sidelink persistent LBT failure (S-PLF) timer for the exclusion time of each RB set of the one or more RB sets, (e.g., S-PLF-timer i for the exclusion time of RB-Set i and S-PLF-timer j for the exclusion time of RB-Set j). In some aspects, each S-PLF timer may be configured, pre-configured, or set with a same value as any of other S-PLF timers of the RB sets or a different value from any of other S-PLF timers of the RB sets. In some aspects, the S-PLF timers may be activated by the UE or a network node from a set of candidate S-PLF timer values configured or pre-configured or dynamically indicated by the UE or a network node, based at least in part on traffic loading, channel condition, LBT performance, QoS or channel access priority class (CAPC) of the data to be transmitted, among other examples.

In some aspects, the resources may be excluded based at least in part on an associated S-PLF timer. The S-PLF timer associated with an RB set may be started after an sidelink persistent LBT failure is detected with the RB set. While the S-PLF timer is running, until stopped or reaching its expiration, resources within the RB set may be excluded from candidate resource selection and/or resource selection. After the S-PLF timer is stopped or expires, the UE may attempt to recover the RB set during a recovery time interval or a recovery window. The recovery window and/or recovery time interval may be configured, pre-configured, or determined by the UE (e.g., RA mode 2) or by the network node (e.g., RA mode 1). For example, the UE or the network node may determine the recovery window and/or recovery time based at least in part on traffic loading, channel condition, LBT performance, QoS or CAPC of the data to be transmitted, among other examples. The UE may recover an RB set from sidelink persistent LBT failure based at least in part on one or more successful LBT procedures (e.g., a channel sensing component of the LBT procedure) at LBT occasions configured or pre-configured or set by the UE (e.g., RA mode 2) or by the network node (e.g., RA mode 1) for recovery within the recovery window. Additionally, or alternatively, the UE may recover an RB set based at least in part on receiving one or more signals or messages within the RB set during the recovery window and/or obtaining one or more CBR and CR and/or RSSI measurements below a threshold (e.g., with the threshold being configured, pre-configured, or determined by UE or network node).

If the RB set is recovered, the resources within the RB set may be included for candidate resource selection and/or resource selection. If the RB set is not recovered, the resources within the RB set may be excluded for candidate resource selection and/or resource selection and the S-PLF timer may be started (e.g., S-PLF-timer i).

As indicated above, FIG. 8 is provided as an example of sidelink persistent LBT failure and recovery with resource inclusion and exclusion. Other examples may differ from what is described with respect to FIG. 8.

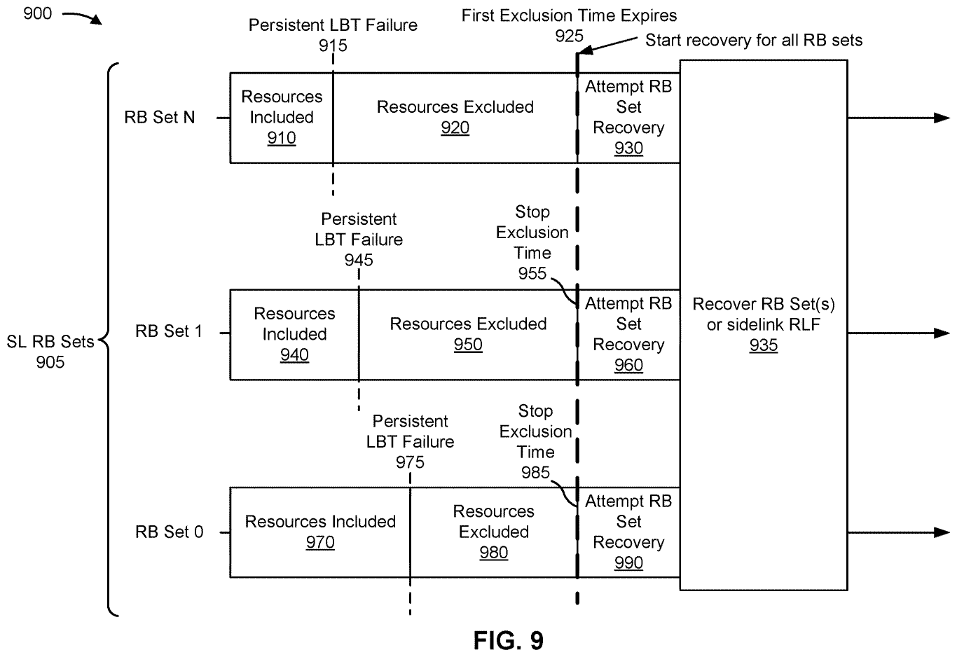

FIG. 9 is a diagram of an example 900 associated with sidelink RLF associated with sidelink persistent LBT failure, in accordance with the present disclosure. In the context of FIG. 9, a UE may attempt to use resources of a group of sidelink RB sets 905 within a resource pool or a sidelink BWP to transmit communications to one or more UEs.

The UE may attempt to use resources of any of RB sets 0 through RB set N to transmit a communication via a sidelink radio link. As shown in FIG. 9, the RB set N may have resources included 910 in a pool for candidate resource selection or resource selection as with RA mode 2 or as configured or activated or indicated by the network node with RA mode 1 for transmitting. The UE may perform an LBT procedure on the RB set N to determine whether resources of the RB set N are available for transmitting a communication while the resources of RB set N are included.

As shown in FIG. 9, the UE may detect sidelink persistent LBT failure 915 which may cause resources of the RB set N to be excluded as resources excluded 920. As shown by reference number 925, a first exclusion time expires (e.g., a first in time with S-PLF timer expiration), which may cause the UE to initiate sidelink persistent LBT failure recovery for all RB sets of the group of RB sets, for example, an RB set recovery 930 for the RB set N (e.g., after the first S-PLF timer expires), a forced RB set recovery 960 for the RB set 1 (e.g., after stopping the S-PLF timer of the RB set 1), a forced RB set recovery 990 for the RB set 0 (e.g., after stopping the S-PLF timer of the RB set 0), etc. Based at least in part on the recovery failing, the resources of RB set N may be identified as resources excluded from the pool of candidate resources for transmitting. Based at least in part on the recovery succeeding, the UE may identify the resources of RB set N as resources included in the pool of candidate resources for transmitting.

As shown in FIG. 9, the RB set 1 may have resources included 940 in the pool for candidate resource selection or resource selection as with RA mode 2 or as configured or activated or indicated by the network node with RA mode 1 for transmitting. The UE may perform an LBT procedure on the RB set 1 to determine whether resources of the RB set 1 are available for transmitting a communication while the resources of RB set 1 are included.

As shown in FIG. 9, the UE may detect sidelink persistent LBT failure 945 which may cause resources of the RB set 1 to be excluded as resources excluded 950. As shown by reference number 955, the UE may stop an exclusion time of the RB set 1 (e.g., stop the S-PLF-timer associated with RB-Set 1) based at least in part on the first exclusion time expiring (e.g., the S-PLF-timer associated with RB set N expiring), which may cause the UE to initiate an RB set recovery 960 for the RB set 1. Based at least in part on the recovery failing, the resources of RB set 1 may be identified as resources excluded from the pool of candidate resources for transmitting. Based at least in part on the recovery succeeding, the UE may identify the resources of RB set 1 as resources included in the pool of candidate resources for transmitting.

As shown in FIG. 9, the RB set 0 may have resources included 970 in the pool for candidate resource selection or resource selection as with RA mode 2 or as configured or activated or indicated by the network node with RA mode 1 for transmitting. The UE may perform an LBT procedure on the RB set 0 to determine whether resources of the RB set 0 are available for transmitting a communication while the resources of RB set 0 are included.

As shown in FIG. 9, the UE may detect sidelink persistent LBT failure 975 which may cause resources of the RB set 0 to be excluded as resources excluded 980. As shown by reference number 985, the UE may stop an exclusion time of the RB set 0 (e.g., stop the S-PLF-timer associated with RB-Set 0) based at least in part on the first exclusion time expiring (e.g., the S-PLF-timer associated with RB set N expiring), which may cause the UE to initiate an RB set recovery 990 for the RB set 0. Based at least in part on the recovery failing, the resources of RB set 0 may be identified as resources excluded from the pool of candidate resources for transmitting. Based at least in part on the recovery succeeding, the UE may identify the resources of RB set 0 as resources included in the pool of candidate resources for transmitting.

As shown by reference number 935, the UE may recover one or more RB sets or identify sidelink RLF based at least in part on results of attempts to recover RB sets. For example, based at least in part on the recovery being successful for the RB set N or any other RB set, the UE may refrain from identifying RLF. Alternatively, based at least in part on the recovery being unsuccessful for any RB set of the group of RB sets (or for a threshold number of RB sets), the UE may identify and/or trigger sidelink RLF.

As indicated above, FIG. 9 is provided as an example. Other examples may differ from what is described with respect to FIG. 9.

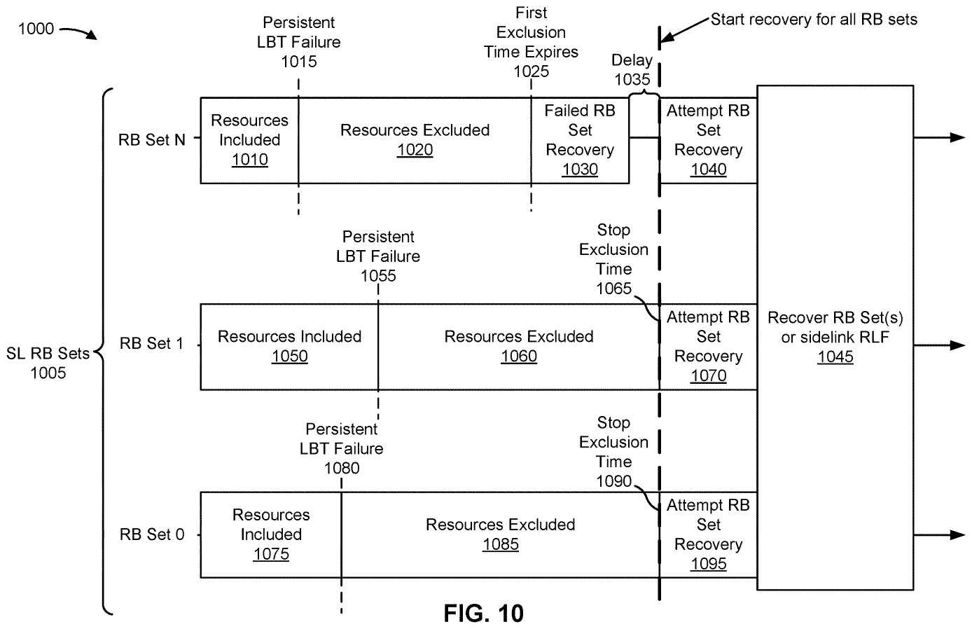

FIG. 10 is a diagram of an example 1000 associated with sidelink RLF associated with sidelink persistent LBT failure, in accordance with the present disclosure. In the context of FIG. 10, a UE may attempt to use resources of a group of sidelink RB sets 1005 which may be within one or multiple resource pools of a sidelink bandwidth part to transmit communications to one or more UEs.

The UE may attempt to use resources of any of RB sets 0 through RB set N to transmit a communication via a sidelink radio link. As shown in FIG. 10, the RB set N may have resources included 1010 in a pool for candidate resource selection or resource selection as with RA mode 2 or as configured or activated or indicated by the network node with RA mode 1 for transmitting. The UE may perform an LBT procedure on the RB set N to determine whether resources of the RB set N are available for transmitting a communication while the resources of RB set N are included.

As shown in FIG. 10, the UE may detect sidelink persistent LBT failure 1015 which may cause resources of the RB set N to be excluded as resources excluded 1020. As shown by reference number 1025, a first exclusion time expires (e.g., a first in time with S-PLF timer expiration), which may cause the UE to initiate a n RB set recovery for the RB set N. Based at least in part on the first RB set recovery failing (failed RB set recovery 1030), the resources of RB set N may be identified as resources excluded from the pool of candidate resources for transmitting. After a delay 1035 from the first RB set recovery failure (failed RB set recovery 1030), the UE may stop any exclusion time unexpired (e.g., any running S-PLF timer) and may trigger an attempt for RB set recovery for all RB sets. For example, the UE may attempt RB set recovery 1040, RB set recovery 1070, RB set recovery 1095, etc.

As shown in FIG. 10, the RB set 1 may have resources included 1050 in the pool for candidate resource selection or resource selection as with RA mode 2 or as configured or activated or indicated by the network node with RA mode 1 for transmitting. The UE may perform an LBT procedure on the RB set 1 to determine whether resources of the RB set 1 are available for transmitting a communication while the resources of RB set 1 are included.

As shown in FIG. 10, the UE may detect sidelink persistent LBT failure 1055 which may cause resources of the RB set 1 to be excluded as resources excluded 1060. As shown by reference number 1065, the UE may stop an exclusion time of the RB set 1 (e.g., stop the S-PLF-timer associated with RB-Set 1) based at least in part on expiration of the delay 1035 from the first RB set recovery failure (failed RB set recovery 1030) after the exclusion time expiring (e.g., the S-PLF-timer associated with RB set N expiring), which may cause the UE to initiate an RB set recovery 1070 for the RB set 1. Based at least in part on the recovery failing, the resources of RB set 1 may be identified as resources excluded from the pool of candidate resources for transmitting. Based at least in part on the recovery succeeding, the UE may identify the resources of RB set 1 as resources included in the pool of candidate resources for transmitting.

As shown in FIG. 10, the RB set 0 may have resources included 1075 in the pool for candidate resource selection or resource selection as with RA mode 2 or as configured or activated or indicated by the network node with RA mode 1 for transmitting. The UE may perform an LBT procedure on the RB set 0 to determine whether resources of the RB set 0 are available for transmitting a communication while the resources of RB set 0 are included.

As shown in FIG. 10, the UE may detect sidelink persistent LBT failure 1080 which may cause resources of the RB set 0 to be excluded as resources excluded 1085. As shown by reference number 1090, the UE may stop an exclusion time of the RB set 0 (e.g., stop the S-PLF-timer associated with RB-Set 0) based at least in part on expiration of the delay 1035 from the first RB set recovery failure (failed RB set recovery 1030) after the exclusion time expiring (e.g., the S-PLF-timer associated with RB set N expiring), which may cause the UE to initiate an RB set recovery for the RB set 0. Based at least in part on the recovery failing, the resources of RB set 0 may be identified as resources excluded from the pool of candidate resources for transmitting. Based at least in part on the recovery succeeding, the UE may identify the resources of RB set 0 as resources included in the pool of candidate resources for transmitting.

As shown by reference number 1045, the UE may recover one or more RB sets or identify sidelink RLF based at least in part on results of attempts to recover RB sets. For example, based at least in part on the recovery being successful for the RB set Nor any other RB set, the UE may refrain from identifying RLF. Alternatively, based at least in part on the recovery being unsuccessful for any RB of the group of RB sets (or for a threshold number of RB sets), the UE may identify and/or trigger RLF.

As indicated above, FIG. 10 is provided as an example. Other examples may differ from what is described with respect to FIG. 10.

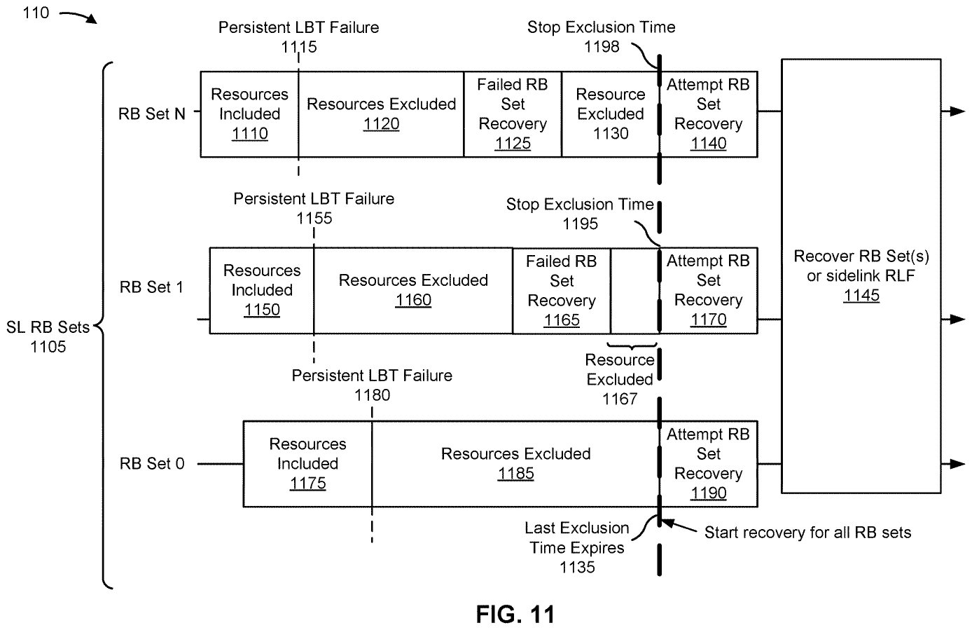

FIG. 11 is a diagram of an example 1100 associated with sidelink RLF associated with sidelink persistent LBT failure, in accordance with the present disclosure. In the context of FIG. 11, a UE may attempt to use resources of a group of sidelink RB sets 1105 which may be within one or multiple resource pools of a sidelink bandwidth part to transmit communications to one or more UEs.

The UE may attempt to use resources of any of RB sets 0 through RB set N to transmit a communication via a sidelink radio link. As shown in FIG. 11, the RB set N may have resources included 1110 in a pool for candidate resource selection or resource selection as with RA mode 2 or as configured or activated or indicated by the network node with RA mode 1 for transmitting. The UE may perform an LBT procedure on the RB set N to determine whether resources of the RB set N are available for transmitting a communication while the resources of RB set N are included.

As shown in FIG. 11, the UE may detect sidelink persistent LBT failure 1115 which may cause resources of the RB set N to be excluded as resources excluded 1120. As shown by reference number 1125, the UE may perform an RB set recovery (e.g., failed RB set recovery 1125) based at least in part on expiration of an exclusion time associated with the RB set N (e.g., expiration of the S-PLF timer associated with the RB set N). Based at least in part on the recovery failing, the resources of RB set N may be identified as resources excluded 1130 from the pool of candidate resources for transmitting (e.g., start the S-PLF timer associated with the RB set N). Based at least in part on the recovery succeeding, the UE may identify the resources of RB set N as resources included in the pool of candidate resources for transmitting.

As shown in FIG. 11, the RB set 1 may have resources included 1150 in the pool for candidate resource selection or resource selection as with RA mode 2 or as configured or activated or indicated by the network node with RA mode 1 for transmitting. The UE may perform an LBT procedure on the RB set 1 to determine whether resources of the RB set 1 are available for transmitting a communication while the resources of RB set 1 are included.

As shown in FIG. 11, the UE may detect sidelink persistent LBT failure 1155 which may cause resources of the RB set 1 to be excluded as resources excluded 1160. As shown by reference number 1165, the UE may perform an RB set recovery (e.g., failed RB set recovery 1165) based at least in part on the expiration of an exclusion time associated with the RB set 1 (e.g., expiration of the S-PLF timer associated with the RB set 1). Based at least in part on the recovery failing, the resources of RB set 1 may be identified as resources excluded 1167 from the pool of candidate resources for transmitting (e.g., start the S-PLF timer associated with the RB set 1). Based at least in part on the recovery succeeding, the UE may identify the resources of RB set 1 as resources included in the pool of candidate resources for transmitting.

As shown in FIG. 11, the RB set 0 may have resources included 1175 in the pool for candidate resource selection or resource selection as with RA mode 2 or as configured or activated or indicated by the network node with RA mode 1 for transmitting. The UE may perform an LBT procedure on the RB set 0 to determine whether resources of the RB set 0 are available for transmitting a communication while the resources of RB set 0 are included.

As shown in FIG. 11, the UE may detect sidelink persistent LBT failure 1180 which may cause resources of the RB set 0 to be excluded as resources excluded 1185. As shown by reference number 1135, the last exclusion time expires, which is associated with the RB set 0 (e.g., expiration of the S-PLF timer associated with the RB set 0). This may cause the UE to initiate an RB set recovery 1190 for the RB set 0. Based at least in part on the recovery failing, the resources of RB set 0 may be identified as resources excluded from the pool of candidate resources for transmitting. Based at least in part on the recovery succeeding, the UE may identify the resources of RB set 0 as resources included in the pool of candidate resources for transmitting.

Additionally, as shown by reference number 1135, a last exclusion time expires (e.g., a last in time S-PLF timer expiration associated with RB set 0), which may cause the UE perform sidelink persistent LBT failure recovery for all RB sets, for example, RB set recovery 1140 for RB set N after stop exclusion time 1198 (e.g., stop S-PLF timer associated with RB set N), RB set recovery 1170 for RB set 1 after stop exclusion time 1195 (e.g., stop S-PLF timer associated with RB set 1), etc. As shown by reference number 1145, the UE may recover one or more RB sets or identify sidelink RLF based at least in part on results of attempts to recover RB sets. For example, based at least in part on the recovery being successful for the RB set N or any other RB set, the UE may refrain from identifying RLF. Alternatively, based at least in part on the recovery being unsuccessful for any RB set of the group of RB sets (or for a threshold number of RB sets), the UE may identify and/or trigger sidelink RLF.

As indicated above, FIG. 11 is provided as an example. Other examples may differ from what is described with respect to FIG. 11.

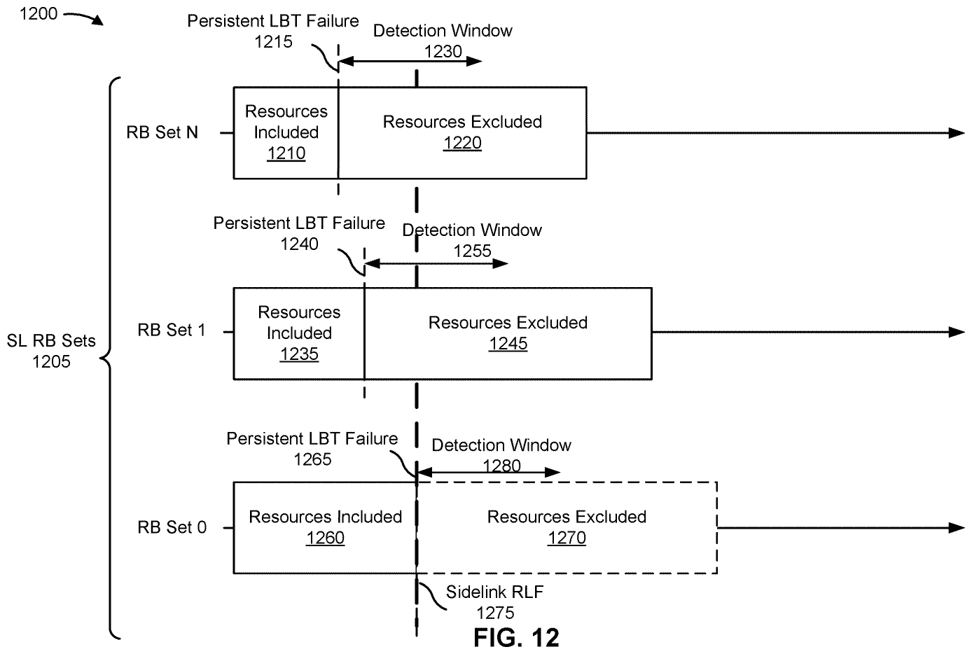

FIG. 12 is a diagram of an example 1200 associated with sidelink RLF associated with sidelink persistent LBT failure, in accordance with the present disclosure. In the context of FIG. 12, a UE may attempt to use resources of a group of sidelink RB sets 1205 which may be within one or multiple resource pools of a sidelink bandwidth part to transmit communications to one or more UEs.

The UE may attempt to use resources of any of RB set 0 through RB set N to transmit a communication via a sidelink radio link. As shown in FIG. 12, the RB set N may have resources included 1210 in a pool for candidate resource selection or resource selection within a detection window (e.g., a resource sensing or selection window) which may be configured, preconfigured or set by the UE or by the network node (when under the coverage of the network node), based on the QoS or channel condition (e.g., congestion level measured with CBR, RSSI, etc.) or LBT performance, as with RA mode 2 for transmitting. The UE may perform an LBT procedure on the RB set N to determine whether resources of the RB set N are available for transmitting a communication while the resources of RB set N are included.

As shown in FIG. 12, the UE may detect sidelink persistent LBT failure 1215 which may cause resources of the RB set N to be excluded as resources excluded 1220 within the detection window (e.g., resource selection window) referenced as 1230.

As shown in FIG. 12, the RB set 1 may have resources included 1235 in a pool for candidate resource selection or resource selection as with RA mode 2 or as configured or activated or indicated by the network node with RA mode 1 for transmitting. The UE may perform an LBT procedure on the RB set 1 to determine whether resources of the RB set 1 are available for transmitting a communication while the resources of RB set 1 are included.

As shown in FIG. 12, the UE may detect sidelink persistent LBT failure 1240 which may cause resources of the RB set 1 to be excluded as resources excluded 1245 within the detection window (e.g., resource selection window) referenced as 1255.

As shown in FIG. 12, the RB set 0 may have resources included 1260 in a pool for candidate resource selection or resource selection as with RA mode 2 or as configured or activated or indicated by the network node with RA mode 1 for transmitting. The UE may perform an LBT procedure on the RB set 0 to determine whether resources of the RB set 0 are available for transmitting a communication while the resources of RB set 0 are included.

As shown in FIG. 12, the UE may detect sidelink persistent LBT failure 1265 which may cause resources of the RB set 0 to be excluded as resources excluded 1270. As shown by reference number 1275, the last sidelink persistent LBT failure detection with the RB set 0, with all other exclusion times unexpired (e.g., sidelink persistent LBT failure 1265 while the respective S-PLF timers associated with the other RB sets of the group of RB sets are still running), may cause the UE to determine whether to trigger sidelink RLF based at least in part on whether all of the sidelink RB sets 1205 have been identified as having sidelink persistent LBT failure during a detection window 1280 before the expiration of any exclusion time. Alternatively, the UE to determine whether to trigger sidelink RLF based at least in part on whether all of the sidelink RB sets 1205 have been in sidelink persistent LBT failure throughout the detection window 1280 before the expiration of any exclusion time.

As indicated above, FIG. 12 is provided as an example. Other examples may differ from what is described with respect to FIG. 12.

FIG. 13 is a diagram illustrating an example process 1300 performed, for example, by a UE, in accordance with the present disclosure. Example process 1300 is an example where the UE (e.g., UE 120) performs operations associated with sidelink RLF associated with sidelink persistent LBT failure.

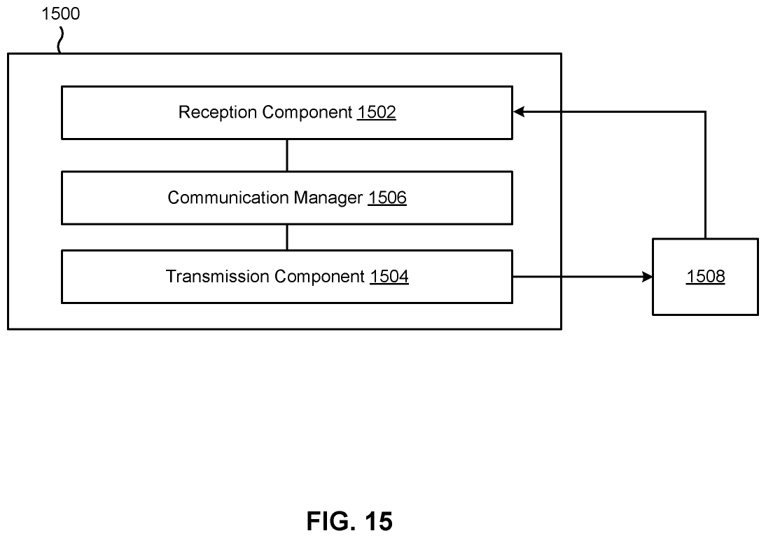

As shown in FIG. 13, in some aspects, process 1300 may include detecting that each RB set of a group of RB sets is in sidelink persistent LBT failure (block 1310). For example, the UE (e.g., using communication manager 1506, depicted in FIG. 15) may detect that each RB set of a group of RB sets is in sidelink persistent LBT failure, as described above.

As further shown in FIG. 13, in some aspects, process 1300 may include attempting to recover one or more RB sets of the group of RB sets (block 1320). For example, the UE (e.g., using communication manager 1506, depicted in FIG. 15) may attempt to recover one or more RB sets of the group of RB sets, as described above.

As further shown in FIG. 13, in some aspects, process 1300 may include selectively identifying sidelink RLF based at least in part on whether the one or more RB sets are recovered (block 1330). For example, the UE (e.g., using communication manager 1506, depicted in FIG. 15) may selectively identify sidelink RLF based at least in part on whether the one or more RB sets are recovered, as described above.

Process 1300 may include additional aspects, such as any single aspect or any combination of aspects described below and/or in connection with one or more other processes described elsewhere herein.

In a first aspect, selectively identifying sidelink RLF based at least in part on whether the one or more RB sets are recovered comprises identifying sidelink RLF based at least in part on failing to recover a threshold number of the one or more RB sets, or refraining from identifying RLF based at least in part on recovery of the threshold number of the one or more RB sets.

In a second aspect, alone or in combination with the first aspect, identifying sidelink RLF is based at least in part on a failure to recover a threshold number of the one or more RB sets based at least in part on one or more of expiration of an exclusion time initiated at detection of a first RB set with sidelink persistent LBT failure, an offset from a first recovery failure after the expiration of an exclusion time initiated at detection of the first RB set with sidelink persistent LBT failure, or expiration of an exclusion time initiated at detection of a last RB set with sidelink persistent LBT failure.

In a third aspect, alone or in combination with one or more of the first and second aspects, attempting to recover the one or more RB sets comprises attempting to recover each of the one or more RB sets.

In a fourth aspect, alone or in combination with one or more of the first through third aspects, process 1300 includes tearing down sidelink radio links with one or more receiving devices based at least in part on identifying the sidelink RLF.

In a fifth aspect, alone or in combination with one or more of the first through fourth aspects, process 1300 includes transmitting, to a network node, an indication of sidelink RLF based at least in part on identifying sidelink RLF.

In a sixth aspect, alone or in combination with one or more of the first through fifth aspects, process 1300 includes including resources of the one or more RB sets, based at least in part on recovery of the one or more RB sets, for resource selection.

In a seventh aspect, alone or in combination with one or more of the first through sixth aspects, process 1300 includes receiving an indication of one or more parameters associated with one or more of a duration of one or more exclusion times, after detection of sidelink persistent LBT, associated with the group of RB sets, a recovery operation used to attempt to recover the one or more RB sets, or a threshold number of the one or more RB sets to be recovered to refrain from identifying sidelink RLF.

In an eighth aspect, alone or in combination with one or more of the first through seventh aspects, the one or more parameters of the recovery operation comprise one or more of a duration of a recovery window, a trigger to initiate the recovery window, or a threshold for detecting availability of an RB set within the recovery window.

In a ninth aspect, alone or in combination with one or more of the first through eighth aspects, process 1300 includes excluding resources of respective RB sets of the group of RB sets after detecting sidelink persistent LBT failure of the respective RB sets, the excluding extending respectively for an exclusion time after detection of sidelink persistent LBT and before attempting to recover the RB set.

In a tenth aspect, alone or in combination with one or more of the first through ninth aspects, the exclusion time is the same for all of the respective RB sets, or wherein the exclusion time is permitted to be different for respective RB sets.

In an eleventh aspect, alone or in combination with one or more of the first through tenth aspects, attempting to recover the one or more RB sets comprises attempting to recover the one or more RB sets in respective recovery windows.

In a twelfth aspect, alone or in combination with one or more of the first through eleventh aspects, attempting to recover a respective RB set of the one or more RB sets in a respective recovery window comprises attempting to recover the respective RB set based at least in part on one or more of performing successful LBT sensing within a respective RB set, receiving one or more signals or communications within the respective RB set, or measuring one or more RLF or RSSI signals to satisfy a threshold.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with sidelink radio link failure associated with sidelink persistent.

As shown in FIG. 14, in some aspects, process 1400 may include detecting sidelink persistent LBT failure of each RB set of a group of RB sets (block 1410). For example, the UE (e.g., using communication manager 1506, depicted in FIG. 15) may detect sidelink persistent LBT failure of each RB set of a group of RB sets, as described above.

As further shown in FIG. 14, in some aspects, process 1400 may include identifying sidelink RLF based at least in part on detection of the sidelink persistent LBT failure of each RB set of the group of RB sets (block 1420). For example, the UE (e.g., using communication manager 1506, depicted in FIG. 15) may identify sidelink RLF based at least in part on detection of the sidelink persistent LBT failure of each RB set of the group of RB sets, as described above.

Process 1400 may include additional aspects, such as any single aspect or any combination of aspects described below and/or in connection with one or more other processes described elsewhere herein.

In a first aspect, process 1400 includes receiving an indication of a duration of a detection window.

In a second aspect, alone or in combination with the first aspect, process 1400 includes tearing down sidelink radio links with one or more receiving devices based at least in part on identifying the sidelink RLF.

In a third aspect, alone or in combination with one or more of the first and second aspects, process 1400 includes transmitting an indication of sidelink RLF based at least in part on identifying RLF.

In a fourth aspect, alone or in combination with one or more of the first through third aspects, process 1400 includes excluding resources of respective RB sets of the group of RB sets after detecting sidelink persistent LBT failure of the respective RB sets, the excluding extending for respective durations of time.

In a fifth aspect, alone or in combination with one or more of the first through fourth aspects, the respective durations of time are the same for all of the respective RB sets, or wherein the respective durations of time are permitted to be different for respective RB sets.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 7-12. Additionally, or alternatively, the apparatus 1500 may be configured to perform one or more processes described herein, such as process 1300 of FIG. 13, process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The communication manager 1506 may detect that each RB set of a group of RB sets is in sidelink persistent LBT failure. The communication manager 1506 may attempt to recover one or more RB sets of the group of RB sets. The communication manager 1506 may selectively identify sidelink RLF based at least in part on whether the one or more RB sets are recovered.

The communication manager 1506 may tear down sidelink radio links with one or more receiving devices based at least in part on identifying the sidelink RLF.

The transmission component 1504 may transmit, to a network node, an indication of sidelink RLF based at least in part on identifying sidelink RLF.

The communication manager 1506 may include resources of the one or more RB sets, based at least in part on recovery of the one or more RB sets, for resource selection.

The reception component 1502 may receive an indication of one or more parameters associated with one or more of a duration of one or more exclusion times, after detection of sidelink persistent LBT, associated with the group of RB sets, a recovery operation used to attempt to recover the one or more RB sets, or a threshold number of the one or more RB sets to be recovered to refrain from identifying sidelink RLF.

The communication manager 1506 may exclude resources of respective RB sets of the group of RB sets after detecting sidelink persistent LBT failure of the respective RB sets, the excluding extending respectively for an exclusion time after detection of sidelink persistent LBT and before attempting to recover the RB set.

The communication manager 1506 may detect sidelink persistent LBT failure of each RB set of a group of RB sets. The communication manager 1506 may identify sidelink RLF based at least in part on detection of the sidelink persistent LBT failure of each RB set of the group of RB sets.

The reception component 1502 may receive an indication of a duration of a detection window.

The communication manager 1506 may tear down sidelink radio links with one or more receiving devices based at least in part on identifying the sidelink RLF.

The transmission component 1504 may transmit an indication of sidelink RLF based at least in part on identifying RLF.

The communication manager 1506 may exclude resources of respective RB sets of the group of RB sets after detecting sidelink persistent LBT failure of the respective RB sets, the excluding extending for respective durations of time.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: detecting that each resource block (RB) set of a group of RB sets is in sidelink persistent listen-before-talk (LBT) failure; attempting to recover one or more RB sets of the group of RB sets; and selectively identifying sidelink radio link failure (RLF) based at least in part on whether the one or more RB sets are recovered.

Aspect 2: The method of Aspect 1, wherein selectively identifying sidelink RLF based at least in part on whether the one or more RB sets are recovered comprises: identifying sidelink RLF based at least in part on failing to recover a threshold number of the one or more RB sets, or refraining from identifying RLF based at least in part on recovery of the threshold number of the one or more RB sets.

Aspect 3: The method of any of Aspects 1-2, wherein identifying sidelink RLF is based at least in part on a failure to recover a threshold number of the one or more RB sets based at least in part on one or more of: expiration of an exclusion time initiated at detection of a first RB set with sidelink persistent LBT failure, an offset from a first recovery failure after the expiration of an exclusion time initiated at detection of the first RB set with sidelink persistent LBT failure, or expiration of an exclusion time initiated at detection of a last RB set with sidelink persistent LBT failure.

Aspect 4: The method of Aspect 3, wherein attempting to recover the one or more RB sets comprises attempting to recover each of the one or more RB sets.

Aspect 5: The method of any of Aspects 1-4, further comprising: tearing down sidelink radio links with one or more receiving devices based at least in part on identifying the sidelink RLF.

Aspect 6: The method of Aspect 5, further comprising: transmitting, to a network node, an indication of sidelink RLF based at least in part on identifying sidelink RLF.

Aspect 7: The method of any of Aspects 1-6, further comprising: including resources of the one or more RB sets, based at least in part on recovery of the one or more RB sets, for resource selection.

Aspect 8: The method of any of Aspects 1-7, further comprising receiving an indication of one or more parameters associated with one or more of: a duration of one or more exclusion times, after detection of sidelink persistent LBT, associated with the group of RB sets, a recovery operation used to attempt to recover the one or more RB sets, or a threshold number of the one or more RB sets to be recovered to refrain from identifying sidelink RLF.

Aspect 9: The method of Aspect 8, wherein the one or more parameters of the recovery operation comprise one or more of: a duration of a recovery window, a trigger to initiate the recovery window, or a threshold for detecting availability of an RB set within the recovery window.

Aspect 10: The method of any of Aspects 1-9, further comprising: excluding resources of respective RB sets of the group of RB sets after detecting sidelink persistent LBT failure of the respective RB sets, the excluding extending respectively for an exclusion time after detection of sidelink persistent LBT and before attempting to recover the RB set.

Aspect 11: The method of Aspect 10, wherein the exclusion time is the same for all of the respective RB sets, or wherein the exclusion time is permitted to be different for respective RB sets.

Aspect 12: The method of any of Aspects 1-11, wherein attempting to recover the one or more RB sets comprises attempting to recover the one or more RB sets in respective recovery windows.

Aspect 13: The method of Aspect 12, wherein attempting to recover a respective RB set of the one or more RB sets in a respective recovery window comprises attempting to recover the respective RB set based at least in part on one or more of: performing successful LBT sensing within a respective RB set, receiving one or more signals or communications within the respective RB set, or measuring one or more channel busy ratio (CBR) or received signal strength indication (RSSI) signals to satisfy a threshold.

Aspect 14: A method of wireless communication performed by a user equipment (UE), comprising: detecting sidelink persistent listen-before-talk (LBT) failure of each resource block (RB) set of a group of RB sets; and identifying sidelink radio link failure (RLF) based at least in part on detection of the sidelink persistent LBT failure of each RB set of the group of RB sets.

Aspect 15: The method of Aspect 14, further comprising receiving an indication of a duration of a detection window.

Aspect 16: The method of any of Aspects 14-15, further comprising: tearing down sidelink radio links with one or more receiving devices based at least in part on identifying the sidelink RLF.

Aspect 17: The method of any of Aspects 14-16, further comprising: transmitting an indication of sidelink RLF based at least in part on identifying RLF.

Aspect 18: The method of any of Aspects 14-17, further comprising: excluding resources of respective RB sets of the group of RB sets after detecting sidelink persistent LBT failure of the respective RB sets, the excluding extending for respective durations of time.

Aspect 19: The method of Aspect 18, wherein the respective durations of time are the same for all of the respective RB sets, or wherein the respective durations of time are permitted to be different for respective RB sets.

Aspect 20: An apparatus for wireless communication at a device, comprising a processor; memory coupled with the processor; and instructions stored in the memory and executable by the processor to cause the apparatus to perform the method of one or more of Aspects 1-19.

Aspect 21: A device for wireless communication, comprising a memory and one or more processors coupled to the memory, the one or more processors configured to perform the method of one or more of Aspects 1-19.

Aspect 22: An apparatus for wireless communication, comprising at least one means for performing the method of one or more of Aspects 1-19.

Aspect 23: A non-transitory computer-readable medium storing code for wireless communication, the code comprising instructions executable by a processor to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
detect that each resource block (RB) set of a group of RB sets is in sidelink persistent listen-before-talk (LBT) failure;
attempt to recover one or more RB sets of the group of RB sets; and selectively identify sidelink radio link failure (RLF) based at least in part on whether the one or more RB sets are recovered.

2. The UE of claim 1, wherein the one or more processors, to selectively identify sidelink RLF based at least in part on whether the one or more RB sets are recovered, are configured to:
identify sidelink RLF based at least in part on failing to recover a threshold number of the one or more RB sets, or
refrain from identifying RLF based at least in part on recovery of the threshold number of the one or more RB sets.

3. The UE of claim 1, wherein identifying sidelink RLF is based at least in part on a failure to recover a threshold number of the one or more RB sets based at least in part on one or more of:
expiration of an exclusion time initiated at detection of a first RB set with sidelink persistent LBT failure,
an offset from a first recovery failure after the expiration of an exclusion time initiated at detection of the first RB set with sidelink persistent LBT failure, or
expiration of an exclusion time initiated at detection of a last RB set with sidelink persistent LBT failure.

4. The UE of claim 3, wherein the one or more processors, to attempt to recover the one or more RB sets, are configured to attempt to recover each of the one or more RB sets.

5. The UE of claim 1, wherein the one or more processors are further configured to:
tear down sidelink radio links with one or more receiving devices based at least in part on identifying the sidelink RLF.

6. The UE of claim 5, wherein the one or more processors are further configured to:
transmit, to a network node, an indication of sidelink RLF based at least in part on identifying sidelink RLF.

7. The UE of claim 1, wherein the one or more processors are further configured to: include resources of the one or more RB sets, based at least in part on recovery of the one or more RB sets, for resource selection.

8. The UE of claim 1, wherein the one or more processors are further configured to receive an indication of one or more parameters associated with one or more of:
a duration of one or more exclusion times, after detection of sidelink persistent LBT, associated with the group of RB sets,
a recovery operation used to attempt to recover the one or more RB sets, or a threshold number of the one or more RB sets to be recovered to refrain from identifying sidelink RLF.

9. The UE of claim 8, wherein the one or more parameters of the recovery operation comprise one or more of:
a duration of a recovery window,
a trigger to initiate the recovery window, or
a threshold for detecting availability of an RB set within the recovery window.

10. The UE of claim 1, wherein the one or more processors are further configured to:
exclude resources of respective RB sets of the group of RB sets after detecting sidelink persistent LBT failure of the respective RB sets, the excluding extending respectively for an exclusion time after detection of sidelink persistent LBT and before attempting to recover the RB set.

11. The UE of claim 10, wherein the exclusion time is the same for all of the respective RB sets, or
wherein the exclusion time is permitted to be different for respective RB sets.

12. The UE of claim 1, wherein the one or more processors, to attempt to recover the one or more RB sets, are configured to attempt to recover the one or more RB sets in respective recovery windows.

13. The UE of claim 12, wherein the one or more processors, to attempt to recover a respective RB set of the one or more RB sets in a respective recovery window, are configured to attempt to recover the respective RB set based at least in part on one or more of:
perform successful LBT sensing within a respective RB set,
receive one or more signals or communications within the respective RB set, or measure one or more channel busy ratio (CBR) or received signal strength indication (RSSI) signals to satisfy a threshold.

14. A user equipment (UE) for wireless communication, comprising:
a memory; and
one or more processors, coupled to the memory, configured to:
detect sidelink persistent listen-before-talk (LBT) failure of each resource block (RB) set of a group of RB sets; and
identify sidelink radio link failure (RLF) based at least in part on detection of the sidelink persistent LBT failure of each RB set of the group of RB sets.

15. The UE of claim 14, wherein the one or more processors are further configured to receive an indication of a duration of a detection window.

16. The UE of claim 14, wherein the one or more processors are further configured to: tear down sidelink radio links with one or more receiving devices based at least in part on identifying the sidelink RLF.

17. The UE of claim 14, wherein the one or more processors are further configured to: transmit an indication of sidelink RLF based at least in part on identifying RLF.

18. The UE of claim 14, wherein the one or more processors are further configured to: exclude resources of respective RB sets of the group of RB sets after detecting sidelink persistent LBT failure of the respective RB sets, the excluding extending for respective durations of time.

19. The UE of claim 18, wherein the respective durations of time are the same for all of the respective RB sets, or
wherein the respective durations of time are permitted to be different for respective RB sets.

20. A method of wireless communication performed by a user equipment (UE), comprising:
detecting that each resource block (RB) set of a group of RB sets is in sidelink persistent listen-before-talk (LBT) failure;
attempting to recover one or more RB sets of the group of RB sets; and selectively identifying sidelink radio link failure (RLF) based at least in part on whether the one or more RB sets are recovered.

21-30. (canceled)
